(19) United States
(12) Patent Application Publication
(10) Pub. No.: US 2010/0238967 A1
(43) Pub. Date: Sep. 23, 2010

(54) METHOD OF PRODUCING A FINE GRAIN CASTING

(76) Inventors: Steven J. Bullied, Pomfret Center, CT (US); John Joseph Marcin, Marlborough, CT (US); Lea Kennard Castle, Vernon, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/406,332

(22) Filed: Mar. 18, 2009

(51) Int. Cl. H05B 6/22; H05B 6/36; H05B 6/34

(52) U.S. Cl. 373/152; 373/142; 219/634; 373/146; 373/155

(57) ABSTRACT

An induction heated furnace assembly for producing a directionally solidified casting includes a susceptor that tailors strength of the magnetic field within the chamber to provide a desired grain structure in a completed cast part. The susceptor proportionally blocks portions of the magnetic field to provide different levels of magnetic stirring within the molten material at different locations within the furnace assembly stirring induced by the magnetic field is controlled and varied throughout the furnace assembly to create the desired grain structures in the completed cast article.

### BACKGROUND OF THE INVENTION

This disclosure generally relates to a method and device for directional solidification of a cast part. More particularly, this disclosure relates to a directional solidification casting process that varies magnetic stirring to provide a desired grain structure.

A directional solidification (DS) casting process is utilized to orientate grain structure within a cast part. The desired orientation is provided by moving a mold from a hot zone within a furnace into a cooler zone at a desired rate. As the mold moves into the cooler zone, the molten material solidifies along a solidification front in one direction.

Mixing of the molten material within the furnace is known to produce a desired grain size. Such mixing can be induced in the molten metal material by a magnetic field generated from a coil encircling the furnace cavity. Typically, an induction furnace utilizes an electric coil that produces heat required for maintaining the metal in a molten state. Insulation is utilized to retain heat within the furnace cavity and a susceptor is utilized to block any magnetic field produced by the electric coil. When magnetic mixing is desired the susceptor is eliminated.

Disadvantageously, a minimum level of current is required to produce the heat required to maintain the metal in a molten state. The current level also controls the strength of the magnetic field. However, the levels required to maintain heat may not provide the desired strength of the magnetic field. Accordingly, it is desirable to design and develop a method and device for controlling the strength of the magnetic field acting on the molten material separate from the heating function of the inductive coil.

### SUMMARY OF THE INVENTION

A disclosed induction heated furnace assembly for producing a directionally solidified casting includes a susceptor that tailors strength of the magnetic field within the chamber to provide a desired grain structure in a completed cast part.

The example susceptor proportionally blocks portions of the magnetic field to provide different levels of magnetic stirring within the molten material within the mold. Stirring induced by the magnetic field is reduced in a direction towards the opening of the chamber through which a cast article is removed in the directional solidification process to create the desired grain structures in the completed cast article.

These and other features of the present invention can be best understood from the following specification and drawings, the following of which is a brief description.

### BRIEF DESCRIPTION OF THE DRAWINGS

FIG. 1 is a schematic illustration of an example inductive furnace with a mold disposed within the furnace.

FIG. 2 is a schematic illustration of the example inductive furnace with the mold partially withdrawn from the furnace.

FIG. 3 is a schematic illustration of another example inductive furnace including a plurality of openings in an example susceptor.

FIG. 4 is a schematic illustration of another example inductive furnace including a single opening in an example susceptor.

FIG. 5 is a schematic illustration of another example inductive furnace including another example susceptor.

FIG. 6 is a schematic illustration of another example inductive furnace that includes an example inductive coil with a variable configuration.

### DETAILED DESCRIPTION OF THE PREFERRED EMBODIMENT

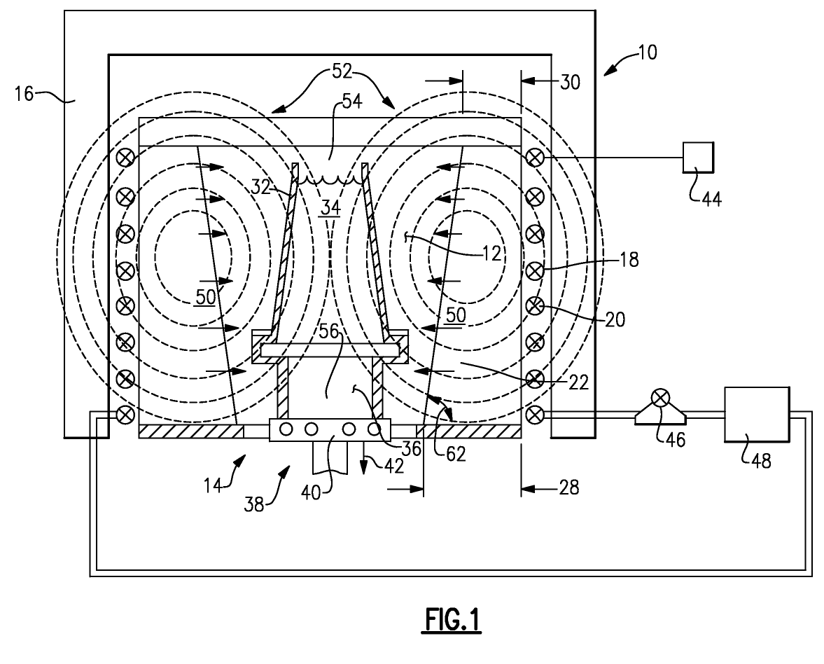

Referring to FIG. 1, an example induction furnace assembly 10 includes a chamber 12 that includes an opening 14 through which a mold 32 is received and withdrawn. The chamber 12 is isolated from the external environment by insulated walls 16. An inductive coil 18 generates heat, indicated by arrows 50, to maintain metal 34 within the mold 32 at a desired temperature.

The example furnace assembly includes a susceptor 22 that blocks a portion of a magnetic field (schematically shown at 52) that is generated by the inductive coil 18. The example susceptor 22 is a wall that surrounds the chamber 12 and is made of a graphite material. The susceptor 22 is fabricated from material such as graphite that blocks the penetration of the magnetic field 52 produced by the inductive coil 18. The susceptor 22 can also provide for the translation of energy from the magnetic field into heat energy, as indicated at arrows 50 to further maintain a temperature within the mold 32. In the disclosed example, molten metal material 34 is disposed in the mold 32 and supported on a support 38. The example support 38 includes a chill plate 40 that both supports the mold 32 and includes cooling features to aid in cooling the molten material 34.

The inductive coil 18 receives electrical energy from an electric power source schematically indicated at 44. This electrical energy is provided at a desired current level determined to provide sufficient power and energy to create the desired temperature within the chamber 12 that maintains the molten metal 34 in a molten state.

The example inductive coil 18 comprises a plurality of electrically conductive hollow tubes 20. The plurality of tubes 20 also provide for the circulation of a fluid that is generated by a pump 46 that supplies fluid from a fluid source 48 to flow through the tubes 20.

In the example a directional solidification casting process is utilized where molten material is poured into the mold 32 within the chamber 12 at a desired temperature to maintain the molten material in a molten state. The support 38 is then lowered through the opening 14 out of the hot chamber 12. The mold 32 is lowered from the chamber 12 at a desired rate to cool the molten material in a controlled manner to produce desired columnar structure. The controlled cooling produces a solidification front within the molten material 34.

In many applications, the completed cast part is desired to include a specific grain structure and size. The size and structure of grains within the completed cast part provide desired material characteristics and performance, such as for example material fatigue performance. In many applications, the finer the grain size the more favorable the performance of the completed cast article. The example furnace assembly 10 includes the susceptor 22 with a varying thickness to block a proportionate amount of the magnetic field 52. The proportional blocking of the magnetic field 52 generates a proportional amount of magnetic stirring within the molten metal material 34.

The generated magnetic field 52 produces currents within the molten metal material that interact with the molten metal material 34 to provide stirring and mixing to break up large grain nuclei to form smaller grain structures. In a standard induction furnace, the susceptor is sized to include a thickness that is thick enough to completely eliminate the generation of any magnetic field within the hot zone of the chamber 12. The example furnace 10 includes a susceptor of a varying thickness such that it can vary the strength of the magnetic field 52 depending on the position of the mold 32 within the chamber 12. In this way a variable stirring can be induced within the molten material to break up the larger grain structures to form smaller and more desirable grains in a completed part.

The example susceptor 22 includes a first thickness 28 disposed at a portion closest to the opening 14. The susceptor 22 also includes a second thickness 30 that is disposed at an end opposite the opening 14. The second thickness 30 is much less then the first thickness 28 to allow the largest portion of the magnetic field 52 to pass into and create stirring.

The example structure of the susceptor 22 provides for the generation of a strongest magnetic field point indicated by 54 and a weakest magnetic field point indicated at 56. Note that points 54 and 56 represent an area or region within the chamber 12 where the magnetic field 52 is at a greatest or weakest strength.

The example Susceptor 22 includes the wall that is sloped at an angle 62 between the first thickness 28 and the second thickness 30. The example susceptor 22 is disposed at a constant angle that provides a uniform increase in thickness in a direction towards the opening 14. The steady increase in the thickness of the susceptor 22 in a direction towards the opening 14 provides for the steady decrease in magnetic field strength generated within the chamber 12. The decrease in the magnetic field strength towards the opening 14 produces a decrease in stirring and mixing encountered within the molten material 34.

It is desirable to decrease the magnetic stirring within the molten material 34 as the mold 32 leaves the hot chamber 12 along the solidification front to produce the desired grain structure within the completed cast part.

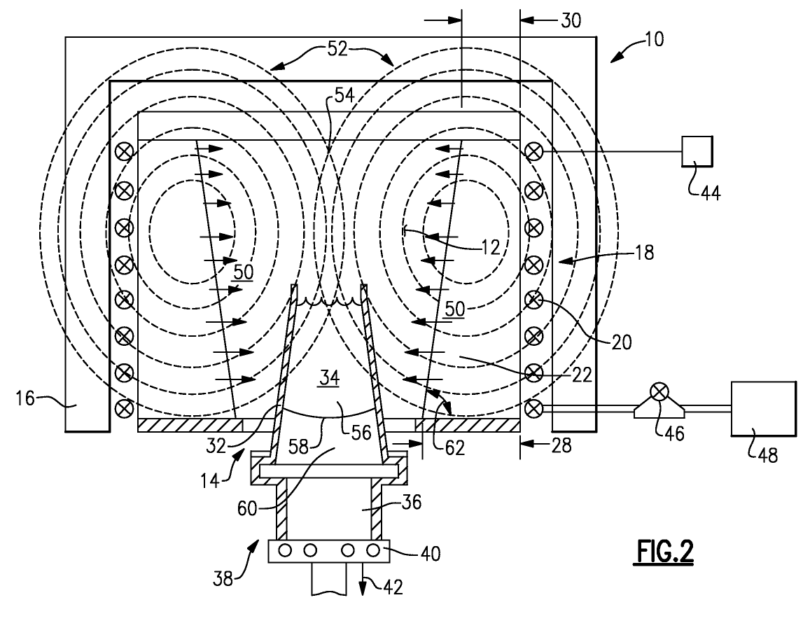

Referring to FIG. 2, with continued reference to FIG. 1, the example furnace 10 is illustrated with the mold 32 partially removed from the hot chamber 12. As the mold 32 is removed, a solidification front 58 is formed within the molten material 34. Mixing at the solidification front does not provide the desired fine grain structure and can disrupt any desired columnar structures, and therefore in some instances it can be desirable to reduce the amount of magnetic mixing along the solidification front 58. The example induction furnace 10 reduces the magnitude of the magnetic field 52 in a direction towards the opening 14 such that as the mold 32 is withdrawn from the hot chamber 12, mixing is slowly reduced until such mixing is completely stopped at a point where the solidification front 58 is formed.

As is schematically shown, the molten material 34 remains above the solidification front 58 and a solidified portion of the desired cast part 60 extends downward from the solidification front 58. The solidification front 58 remains substantially stationary relative to the opening 14 as the mold 32 is moved downwardly and out of the chamber 12.

This process may also be utilized in concert with a single crystal seed 36 or can use other directional solidification processes to create the desired grain structure. The amount of magnetic stirring can be tailored to provide varying amounts of mixing to induce formation of the desired grain structure in a completed part.

In operation, the furnace 10 is brought up to a desired temperature by providing a sufficient current from the electric power source 44 to the inductive coil 18. Water supplied from the pump 46 and fluid source 48 is pumped through the plurality of tubes 20 that make up the inductive coil 18. The heat 50 created by the inductive coil 12 and also created by a partial conversion of the magnetic field by the susceptor 22 heats the chamber 12 to a desired temperature. Once a desired temperature is reached, molten material 34 is poured into the mold 32. The mold 32 defines the external shape and features of the completed cast article. In this example, a seed 36 is placed within the mold 32 to further orientate the desired grain structure of the completed cast article.

The mold 32 is placed on a support 38. The support 38 is movable in a direction axially into and out of the chamber 12. Support 38 also includes the chill plate 40 that is supplied with a coolant to maintain a desired cooling temperature to encourage cooling in a uniform manner. With the mold in the chamber 12, molten material 34 is filled within the mold 32. Once molten material 34 is received within the mold 32, the magnetic field 52 generates a mixing and stirring motion within the molten material 34. This mixing and stirring is governed by the strength of the magnetic field 52.

The shape and thickness of the example susceptor 22 governs the strength of the magnetic field 52 by blocking a desired portion of that magnetic field generated by the inductive coil 18. In this example, the susceptor 22 includes the increasing thickness to proportionally block a greater amount of the magnetic field 52 in a direction toward the opening 14. At the top most portion of the chamber 12, where the magnetic field 52 is at the greatest strength the susceptor 22 is at its smallest thickness 30. As appreciated, the susceptor thicknesses can be adapted to provide the specific magnetic field and stirring properties required to provide the desired grain structure in the completed cast article.

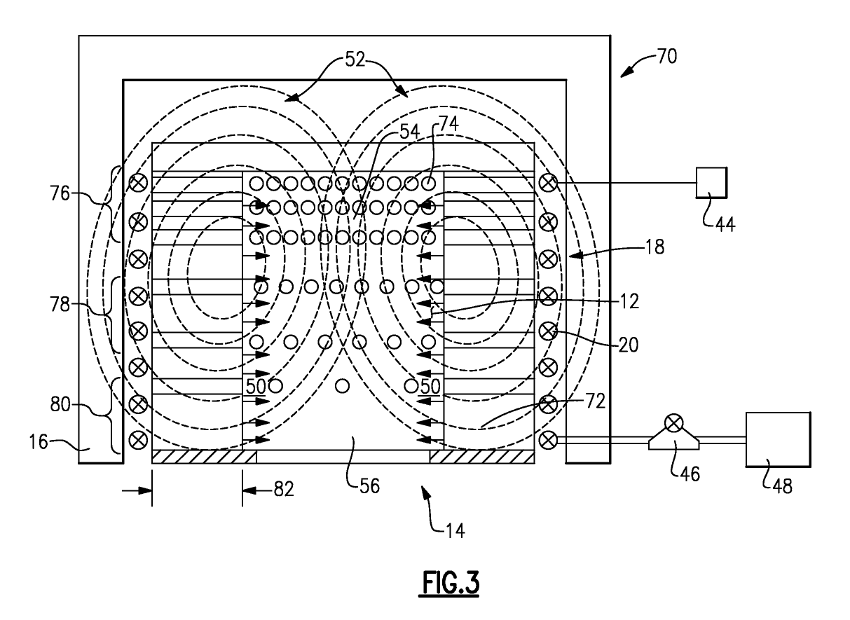

Referring to FIG. 3, another example furnace assembly 70 includes a susceptor 72 that includes a plurality of openings 74. The plurality of openings provides for a portion of the magnetic field 52 generated by the inductive coils 18 to enter the chamber 12. Accordingly, the strength of the magnetic field 52 is proportionally controlled by the number and area of the openings within the susceptor 72.

In this example, the susceptor 72 includes at least three zones of openings. In a first zone 76, a large number of openings 74 are provided to allow the generation and strength of the magnetic field 52 to be at its greatest part. In this example, that zone is provided at the top most part of the chamber 12.

A second or intermediate zone 78 is disposed between the first zone 76 and a third zone 80. This second zone 78 provides an intermediate level or strength of a magnetic field to find an intermediate mixing. The third zone 80 blocks a greater portion of the magnetic field 52 to provide the least amount of mixing and blocks most of the magnetic field 52 at a point where the magnetic field 52 within the chamber 12 is at its weakest as is indicated by 56. The openings 74 are disposed through the entire thickness of the susceptor 72 and provide for the proportional control of the magnitude of the strength of the magnetic field that is encountered within the chamber 12.

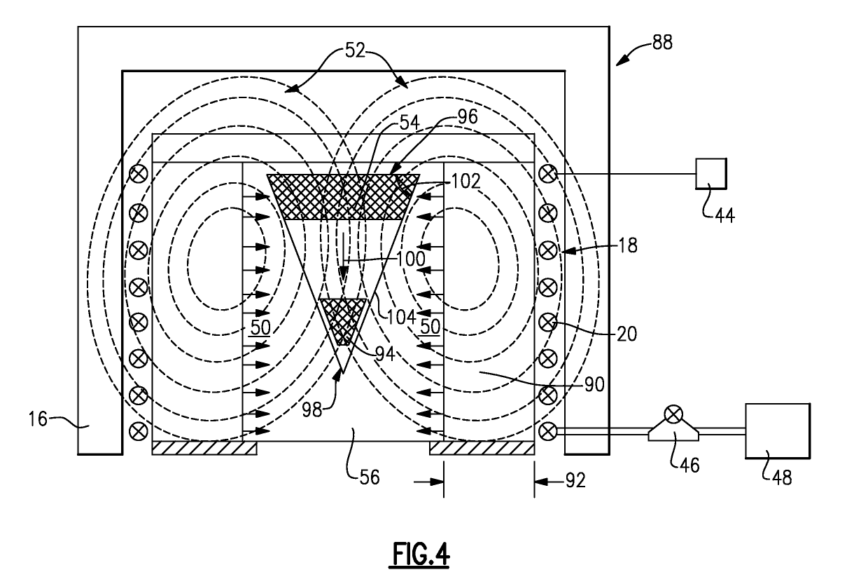

Referring to FIG. 4, another example susceptor 90 is provided for another furnace assembly 88. The susceptor 90 of this example includes a large opening 96. The large opening 96 includes an area 100 that decreases in a direction towards the opening 14. In this example, the opening 96 is triangular shaped having the base or largest width portion disposed at a top most portion of the chamber 12. The sides 104 are disposed at an angle 102 that decreases to a point 98 and smallest area 94 in a direction towards the opening 14 such that the magnetic field 52 that is blocked from entering the chamber 12 increases in a direction towards the opening 14 and withdrawal of the mold from the furnace assembly 88.

The example opening 96 includes the sides 104 disposed at a decreasing angle 102. This angle 102 is a uniform and constant to provide a proportional reduction in magnetic strength in a direction towards the opening 14. This decrease in the opening 96 provides for a change in area from a largest area 96 at the top most portion to a smaller area 94 at the bottom most portion. Decreasing area 100 of the opening 96 provides for the controlled reduction in the magnetic field 52 that is utilized for stirring molten material within the example furnace assembly 10.

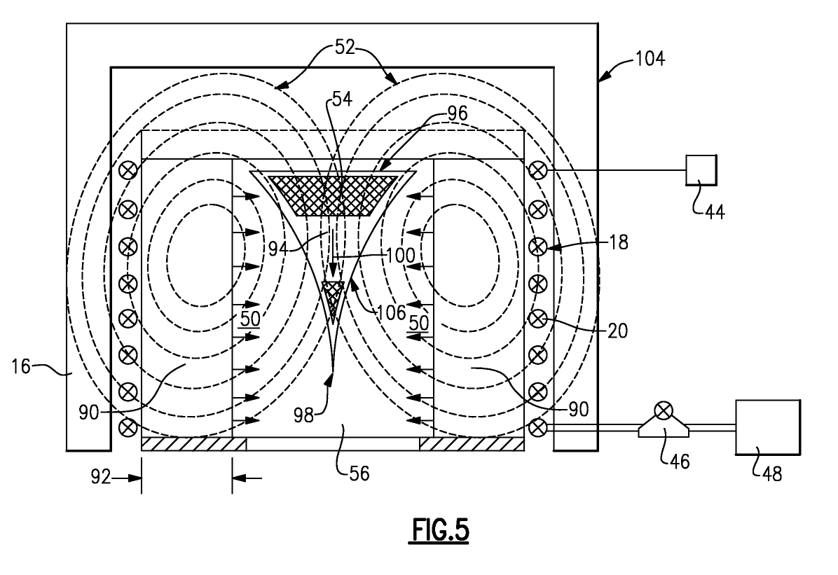

Referring to FIG. 5, another furnace assembly 105 is illustrated and includes the opening 96. The opening 96 also includes a decreasing area 100. However, the opening 96 differs from the previous example in that the side 106 is at a non-uniform angle. This non-uniform angle is utilized to tailor the strength of the magnetic field 52 as it decreases from a greatest amount of magnetic strength to a least amount of magnetic strength. As appreciated, the shape of the opening 96 can be modified to tailor the magnetic field strength and thereby the amount of mixing of the molten material.

As appreciated, the several different embodiments of the example inductive furnace assemblies all provide proportionate blocking of the magnetic field 52 to tailor the strength of the magnetic field based on a position of the mold to further tailor mixing and stirring of the molten material of the cast part. Other areas and shapes of opening can be utilized to block portions of the magnetic field that are to generate the desired stirring that provides the desired final grain structure in the cast article.

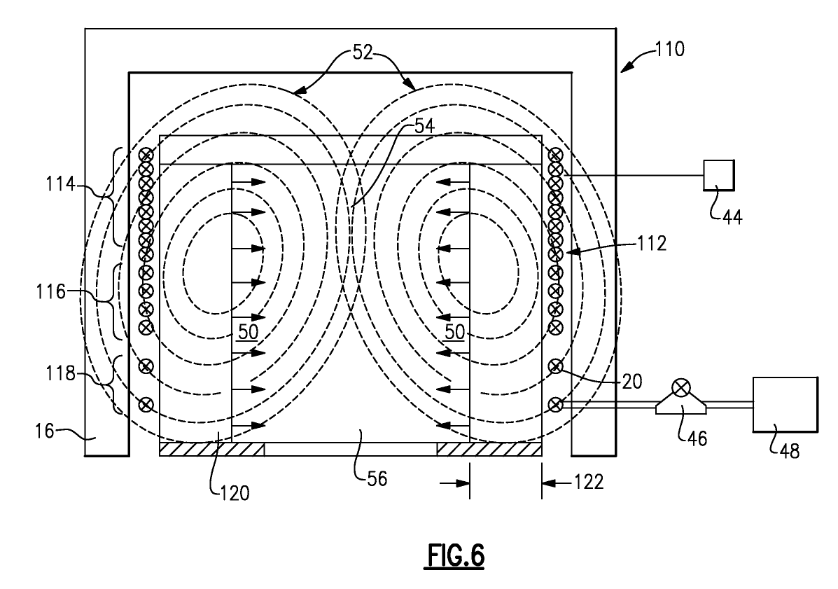

Referring to FIG. 6, another example induction furnace assembly 110 includes an inductive coil 112 that has a variable number of turns to tailor the strength of the magnetic field 52 produced with in the chamber 124. The example inductive coil 112 includes portions with different numbers of windings per axial distance. The number of windings for a given current supplied by the power source 44 creates a desired magnitude of the magnetic field 52 that is produced. Increasing or decreasing the number of windings changes the strength of the magnetic field 52 that is generated.

In this example, the susceptor 120 includes a fixed thickness 122 for the entire axial length of the chamber 12. The inductive coil 112 includes three different zones each having different numbers of windings per axial length. The first set of windings 114 includes a high number of windings to produce the greatest strength of the magnetic field 52 within the chamber 12.

A second number of turns 116 produce an intermediate magnetic field strength within the chamber 12. A third number 118 is smaller than both the second 116 and first 114 number of turns and produces the least amount of magnetic field strength. In this example, the least amount of magnetic field strength is provided by the group of windings 118 disposed at a lower portion of the furnace assembly 110. The modification of the inductive coil 112 provides the desired tailoring and proportional reduction in magnetic field strength within the chamber 12 desired to create variable mixing dependent on the axial position of the mold as it is being lowered from the furnace assembly 110.

Accordingly, the disclosed example inductive furnace assemblies provide for the generation and control of varying amounts of magnetic stirring based on a position of the mold that in turn produce the desired grain structures with the cast part.

Although an example embodiment of this invention has been disclosed, a worker of ordinary skill in this art would recognize that certain modifications would come within the scope of this invention. For that reason, the following claims should be studied to determine the true scope and content of this invention.

What is claimed is:

1. An induction heated furnace assembly for producing a directionally solidified casting, the furnace assembly comprising:
a housing defining a chamber including an opening for receiving and withdrawing a mold containing molten material for forming a cast part;
an induction coil for generating heat and a magnetic field within the chamber;
a susceptor for limiting a strength of the magnetic field within the chamber based on a location within the chamber, wherein the strength of the magnetic field is different based on a position within the chamber to provide different amounts of magnetic stirring of molten material within the mold; and
a movable support for moving a mold into and out of the chamber.

2. The assembly as recited in claim 1, wherein the susceptor blocks a portion of the magnetic field produced by the induction coil to control the strength of the magnetic field within the chamber.

3. The assembly as recited in claim 2, wherein the portion of the magnetic field blocked by the susceptor increases in a direction toward the opening for receiving the mold.

4. The assembly as recited in claim 1, wherein the susceptor includes a wall thickness that increases in a direction toward the opening in the chamber, wherein the amount of the magnetic field blocked by the susceptor increases with an increase in wall thickness.

5. The assembly as recited in claim 4, wherein the susceptor includes a first wall thickness disposed a distance from the opening in the chamber a greater distance than a second wall thickness, the first wall thickness blocking less of the magnetic field then the second wall thickness.

6. The assembly as recited in claim 4, wherein the wall thickness varies uniformly from a least thickness to a greatest thickness.

7. The assembly as recited in claim 4, wherein the wall thickness varies non-uniformly from a least thickness to a greatest thickness.

8. The assembly as recited in claim 1, wherein the susceptor includes openings that define an open space through a wall of the susceptor, an area of open space decreasing in a direction toward the opening in the chamber.

9. The assembly as recited in claim 6, wherein the open space comprises a plurality of openings spaced apart, with the number of openings decreasing in a direction toward the opening in the chamber.

10. The assembly as recited in claim 6, wherein the open space comprises an area decreasing in a direction toward the opening in the chamber.

11. An induction heated furnace assembly for producing a directionally solidified casting, the furnace assembly comprising:
a housing defining a chamber including an opening for receiving and withdrawing a mold containing molten material for forming a cast part;
an induction coil for generating heat and a magnetic field within the chamber, wherein the induction coil produces a magnetic field that varies in strength based on a position within the chamber;
a susceptor for limiting a strength of the magnetic field within the chamber; and
a movable support for moving a mold into and out of the chamber.

12. The assembly as recited in claim 11, wherein the strength of the magnetic field within the chamber decreases in a direction toward the opening in the mold.

13. The assembly as recited in claim 11, wherein the induction coil includes a plurality of tubes, the plurality of tubes include a desired number of windings for a given axial length of the chamber, the desired number of windings decreasing in a direction toward the opening in the chamber to produce the magnetic field that varies in strength based on a position within the mold.

14. The assembly as recited in claim 11, wherein in the induction coil includes a plurality of tubes arranged in a winding about the chamber, the number of windings per axial length decreasing in a direction toward the opening in the chamber.

15. The assembly as recited in claim 11, wherein the induction coil includes a plurality of tubes, wherein an inner diameter of the plurality of tubes decreases in a direction toward the opening in the chamber.

16. The assembly as recited in claim 11, wherein the induction coil comprises more than one separate coil surrounding the chamber.

17. A method of forming a cast article in a directional solidification process comprising the steps of:
generating heat within a chamber at to maintain a molten material in a desired molten state;
generating a magnetic field within the chamber to induce stirring of the molten material within a mold;
cooling the molten material within the mold by withdrawing the mold from the chamber;
changing the magnetic field within the chamber to control stirring of the molten material based on a position of the mold within the chamber as the mold is withdrawn from the chamber; and
removing the mold from the chamber and removing the cast article from the mold once the molten material solidifies.

18. The method as recited in claim 17, including changing the magnetic field to reduce stirring of the molten material along a solidification front to obtain a desired grain structure.

19. The method as recited in claim 18, including reducing the magnetic field in a direction the same as the direction in which the mold is withdrawn from the chamber such that substantially no mixing occurs at the solidification front of the cast article.

20. The method as recited in claim 17, wherein a solidification front substantially corresponds with that portion of the mold and cast article disposed at the opening in the chamber.
